(19) United States
(12) Patent Application Publication
(10) Pub. No.: US 2014/0156258 A1
(43) Pub. Date: Jun. 5, 2014

(54) FOREIGN LANGUAGE WRITING SUPPORT APPARATUS AND METHOD

(71) Applicant: KABUSHIKI KAISHA TOSHIBA, Tokyo (JP)

(72) Inventor: Hirokazu SUZUKI, Machida-shi (JP)

(73) Assignee: KABUSHIKI KAISHA TOSHIBA, Tokyo (JP)

(21) Appl. No.: 14/089,231

(22) Filed: Nov. 25, 2013

(30) Foreign Application Priority Data
Nov. 30, 2012 (JP) 2012-262297

(51) Int. Cl. G06F 17/28

(52) U.S. Cl. CPC G06F 17/289
USPC 704/3

(57) ABSTRACT

According to one embodiment, a foreign language writing support apparatus includes following units. The input unit receives input of a sentence in a foreign language including a word in another language. The dictionary search unit performs a dictionary search for the word to acquire a translated word. The candidate generation unit generates one or more foreign language sentence candidates including a first foreign language sentence candidate generated by replacing the word in the other language with the translated word. The display unit displays the foreign language sentence candidates together with the machine translation results.

### CROSS-REFERENCE TO RELATED APPLICATIONS

This application is based upon and claims the benefit of priority from Japanese Patent Application No. 2012-262297, filed Nov. 30, 2012, the entire contents of which are incorporated herein by reference.

### FIELD

Embodiments described herein relate generally to a foreign language writing support apparatus and method for supporting writing of a foreign language sentence.

### BACKGROUND

A foreign language writing support apparatus which supports the user to write a sentence in a foreign language (that is, a language other than the mother language) is known. A conventional foreign language writing support apparatus translates a sentence input by the user in the mother language into a desired foreign language by machine translation, and the user edits the machine translation result. However, when the machine translation result is largely different from the sentence intended by the user, the user has to make many correction operations. Furthermore, when the user has knowledge about the desired foreign language to some extent, correction of the machine translation result merely causes stress for the user.

The foreign language writing support apparatus is required to support writing of a foreign language sentence so that the user can smoothly write a sentence in a foreign language.

### BRIEF DESCRIPTION OF THE DRAWINGS

FIG. 1 is a block diagram schematically showing a foreign language writing support apparatus according to the first embodiment;

FIG. 2A is a block diagram showing an example of a word string generation unit shown in FIG. 1;

FIG. 2B is a block diagram showing another example of the word string generation unit shown in FIG. 1;

FIG. 3 is a view showing a foreign language sentence input screen according to the first embodiment;

FIG. 4 is a view showing the foreign language sentence candidate display screen according to the first embodiment;

FIG. 5 is a flowchart schematically showing an operation of the foreign language writing support apparatus shown in FIG. 1; and

FIG. 6 is a view showing a foreign language sentence candidate display screen according to the second embodiment.

### DETAILED DESCRIPTION

In general, according to one embodiment, a foreign language writing support apparatus includes an input unit, a dictionary search unit, a candidate generation unit, a machine translation unit, and a display unit. The input unit is configured to receive input of a sentence in a foreign language including a word in another language. The dictionary search unit is configured to perform a dictionary search for the word in the other language and to acquire a translated word which is a word in the foreign language corresponding to the word in the other language. The candidate generation unit is configured to generate one or more foreign language sentence candidates including a first foreign language sentence candidate generated by replacing the word in the other language with the translated word. The machine translation unit is configured to generate one or more machine translation results by applying machine translation to the one or more foreign language sentence candidates. The display unit is configured to display the one or more foreign language sentence candidates together with the one or more machine translation results.

Hereinafter, a foreign language writing support apparatus and method according to embodiments will be described with reference to the accompanying drawings.

### First Embodiment

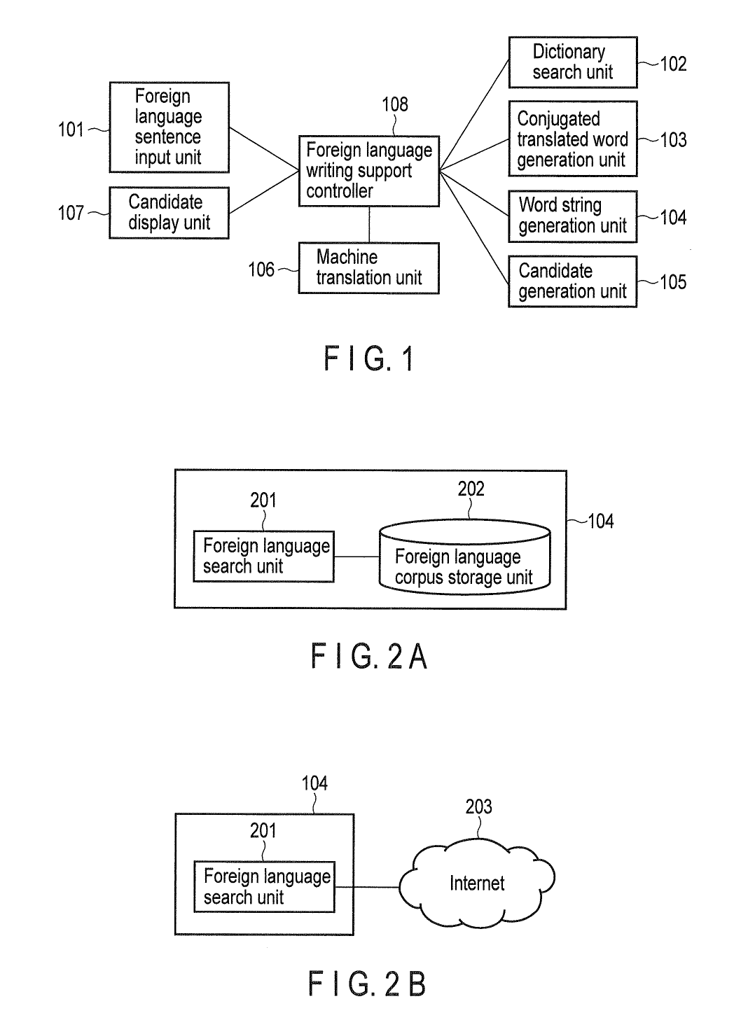

FIG. 1 schematically shows a foreign language writing support apparatus according to the first embodiment. The foreign language writing support apparatus supports a user to write a sentence in a foreign language. Specifically, the foreign language writing support apparatus includes a foreign language sentence input unit 101, dictionary search unit 102, conjugated translated word generation unit 103, word string generation unit 104, candidate generation unit 105, machine translation unit 106, candidate display unit 107, and foreign language writing support controller (to be also simply referred to as a controller hereinafter) 108, as shown in FIG. 1. The controller 108 controls the units 101 to 107.

The foreign language sentence input unit 101 receives input of a foreign language sentence i.e., a sentence in a foreign language. Specifically, the foreign language sentence input unit 101 includes an input device such as a keyboard, mouse, and touchpad, and acquires a foreign language sentence input by the user by operating the input device. When the user does not know a part (for example, a word, idiom, and the like) of a foreign language sentence to be written, the user inputs a foreign language sentence in which the unknown part is described using a word of another language (for example, a mother language).

The dictionary search unit 102 performs a dictionary search for the word in the other language, which is included in the input foreign language sentence, to acquire a foreign language word corresponding to the word in the other language. The word in the other language to be subjected to the dictionary search is also called a search index, search word, or the like, and the foreign language word which is acquired by the dictionary search unit 102 and corresponds to the word in the other language is also called a translated word. When the word in the other language is appended with conjugated form information, the conjugated translated word generation unit 103 conjugates the translated word acquired by the dictionary search unit 102 according to the conjugated form information. The translated word which has undergone the conjugation processing is called a conjugated translated word. The conjugated form information can include information which indicates a part of speech (for example, verb, adjective, adverb, noun, and the like) of a word, and information which designates a conjugated form of the word. When the word is a verb, examples of the conjugated form include a present form, past form, and the like; when the word is an adjective, they include a comparative, superlative, and the like; or when the word is a noun, they include a singular, plural, and the like.

The word string generation unit 104 acquires an extended word string including the translated word or conjugated translated word. As shown in FIG. 2A, the word string generation unit 104 of the present embodiment includes a foreign language corpus storage unit 202 which stores a foreign language corpus, and a foreign language search unit 201 which searches the foreign language corpus stored in the foreign language corpus storage unit 202 using a translated word or conjugated translated word to generate an extended word string including the translated word or conjugated translated word. As the foreign language corpus, it is possible to use a corpus in which various documents such as foreign language documents on Web sites, in-house foreign language documents, and foreign language literatures are registered in advance. In the present embodiment, existing arbitrary techniques can be used for a type, a search method, building method, storage method, and the like of a corpus. In another embodiment, the foreign language search unit 201 may generate an extended word string by conducting a Web search via the Internet 203, as shown in FIG. 2B.

The candidate generation unit 105 generates a foreign language sentence candidate by replacing the word in the other language with the translated word or conjugated translated word in a foreign language sentence. If the word string generation unit 104 acquires an extended word string, the candidate generation unit 105 further generates a foreign language sentence candidate by replacing the word in the other language with the extended word string. The machine translation unit 106 applies machine translation to the foreign language sentence candidate generated by the candidate generation unit 105. The candidate display unit 107 displays the foreign language sentence candidate and corresponding machine translation result side by side on a display device.

The foreign language writing support apparatus according to the present embodiment receives input of a foreign language sentence in which an unknown part is described in the other language, generates one or more foreign language sentence candidates based on the foreign language sentence, and presents the foreign language sentence candidates to the user together with machine translation results. Thus, the user can select an appropriate foreign language sentence from the foreign language sentence candidates, thus allowing the user to smoothly write a foreign language sentence.

The operation of the foreign language writing support apparatus will be concretely described below. A foreign language and a mother language can be arbitrary languages. The following description will be given under the assumption that the foreign language is English, and the mother language is Japanese. This corresponds to a case in which a Japanese user writes a sentence in English.

In the present embodiment, as a practical example, assume that the user writes an English sentence having a meaning of the following Japanese sentence (1):

[ [symbol] [symbol] ](1)

Note that the Japanese sentence (1) corresponds to, for example, the English sentence [He moved to Tokyo].

In this example, assume that the user knows a basic grammar, and that an English translation of a Japanese word [ [symbol] ] is [He], and an English translation of a Japanese word [ [symbol] ] is [Tokyo]. That is, assume that the user recognizes that an English translation (for example, a verb in a past form or a combination of a verb in a past form and preposition) corresponding to a Japanese word (verb) [ [symbol] ] is disposed between [He] and [Tokyo] like SV (Subject—Verb) or SVO (Subject—Verb—Object). However, the user does not know the followings:
an English word corresponding to a Japanese word [ [symbol] [symbol] ]; and
a past form of the English word.

Note that the Japanese word [ [symbol] ] is the past form of the Japanese word [ [symbol] ].

In the conventional method, a dictionary search is performed by inputting a keyword [ [symbol] ] or [ [symbol] ] in a dictionary search query. In general, a plurality of translated word candidates are obtained as the dictionary search result. The user has to select a translated word which appears to be appropriate from the plurality of translated word candidates, and has to look up a past form of the selected translated word. Finally, the user completes the sentence using the looked-up word. Such a sequence is very troublesome, and disturbs smooth writing of an English sentence by the user.

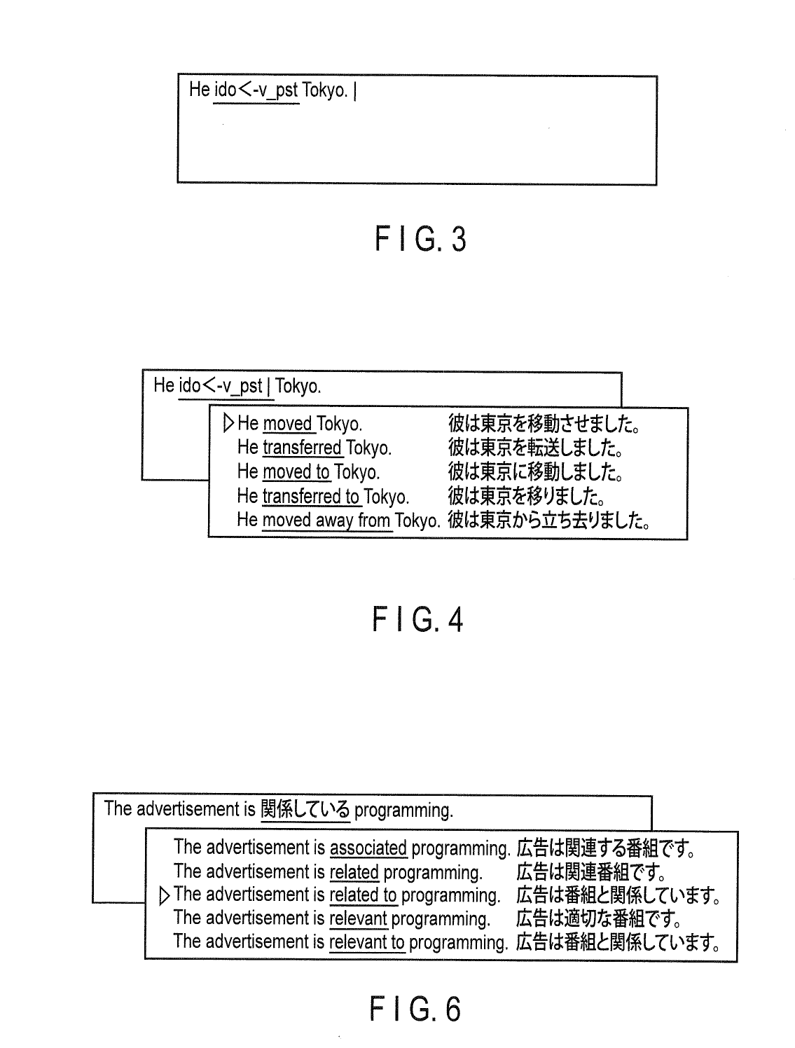

In the present embodiment, the user inputs an English sentence indicated by a sentence (2) below at the foreign language sentence input unit 101. FIG. 3 shows an example of a foreign language sentence input screen to which the sentence (2) is input.

He ido<-v_pst Tokyo. (2)

That is, the user disposes, as a search index, “ido” obtained by reading the Japanese word [ [symbol] ] as a Roman letter word at a position where the English translation of the Japanese word [ [symbol] ] should be placed. In the sentence (2), conjugated form information “<-v_pst” is appended to the search index “ido”. The conjugated form information “<-v_pst” indicates that the search index “ido” is a verb, and is conjugated to a past form (pst is an abbreviation for past). Note that a description method of the conjugated form information is not limited to that in the sentence (2), and any other description methods may be used as long as it can notify what kind of a conjugated form of that word the user wants to use.

Note that underlines of FIG. 3, the sentence (2), and sentences (3) to (6) to be described later are added to emphasize a search index and conjugated form information for the sake of convenience, and are not input by the user.

Upon detection of the input sentence (2) above to the foreign language sentence input unit 101, the controller 108 controls the dictionary search unit 102, conjugated translated word generation unit 103, word string generation unit 104, candidate generation unit 105, machine translation unit 106, and candidate display unit 107 as follows, so as to support the user to write an English sentence.

The dictionary search unit 102 extracts the search index “ido” from the input Japanese sentence “ido<-v_pst”, and performs a dictionary search for this search index “ido”.

Note that the present embodiment assumes the case in which the search index “ido” is input. Alternatively, sentences (3) to (6) below may be input.

He [symbol] <-v_pst Tokyo. (3)

He [symbol] <-v_pst Tokyo. (4)

He [symbol] <-pst Tokyo. (5)

He [symbol] Tokyo. (6)

The sentence (3) is an input example of a search index using hiragana letters (i.e., Japanese syllabary characters). The sentences (4) to (6) are input examples of search indices using kanji letters. The sentence (5) includes a search index [ [symbol] ], and it can be judged by morphological analysis that the search index is a verb. Hence, as conjugated form information, information indicating that a search index is a verb is omitted, and information “<-pst” which designates conjugation to a past form is appended. The sentence (6) includes a search index [ [symbol] ], and it can be judged by morphological analysis that the search index is a past form of a verb. Hence, conjugated form information is omitted. In this manner, when a part of speech and conjugated form can be judged from a search index, conjugated form information need not be explicitly appended. To describe a search index to allow judgment of a part of speech and conjugated form has practically the same meaning as to append conjugated form information. In such case, the conjugated translated word generation unit 103 or controller 108 executes morphological analysis to judge a part of speech and conjugated form from a search index.

A dictionary used by the dictionary search unit 102 is not particularly limited as long as it corresponds to an input form (for example, hiragana, kanji, and Roman letters) of a search index, and a translated word corresponding to the search index can be searched for.

In this example, assume that the dictionary search unit 102 acquires the following two translated words as results of the dictionary search for the search index “ido”.

move ( [symbol] )

transfer ( [symbol] )

Note that the Japanese word [ [symbol] ] is also written as “ido” in the roman letters.

Next, the conjugated translated word generation unit 103 generates past forms of these words according to the conjugated form information “<-v_pst”, thus generating the following two conjugated translated words.

moved

transferred

By replacing an input character string “ido<-v_pst” with “moved” and “transferred”, English sentences indicated by sentences (7) and (8) below are created.

He moved Tokyo. (7)

He transferred Tokyo. (8)

The sentences (7) and (8) are grammatically correct, but do not have the meaning of the sentence (1) intended by the user. In this manner, after a dictionary is looked up for a word to generate an appropriate conjugated form, simple replacement of that word may often fail to obtain a desired sentence.

The word string generation unit 104 (more specifically, the foreign language search unit 201) checks n-gram of word strings including the verb “moved” in the foreign language corpus to acquire a word connectable to the verb “moved”. Furthermore, the word string generation unit 104 checks n-gram of a word string including the verb “transferred” in the foreign language corpus to acquire a word connectable to the verb “transferred”. A connectable word includes a preposition in case of English. The word string generation unit 104 acquires prepositions which are adjacent to “moved” and “transferred” from the foreign language corpus, and couples the acquired prepositions to “moved” and “transferred” to generate extended word strings. In this case, assume that prepositions “to” and “away from” are obtained as corpus search results for “moved”, and a preposition “to” is obtained as a corpus search result for “transferred”. Thus, three extended word strings “moved to”, “transferred to”, and “moved away from” are generated.

The candidate generation unit 105 replaces the input character string “ido<-v_pst” with the conjugated translated words generated by the conjugated translated word generation unit 103 and the extended word strings generated by the word string generation unit 104, thereby generating English sentence candidates indicated by sentences (9) to (13) below.

He moved Tokyo. (9)

He transferred Tokyo. (10)

He moved to Tokyo. (11)

He transferred to Tokyo. (12)

He moved away from Tokyo. (13)

Subsequently, the machine translation unit 106 applies machine translation to the English sentence candidates (9) to (13) to generate corresponding Japanese translated sentences indicated by sentences (14) to (18) below.

He moved Tokyo. [symbol] [symbol] (14)

He transferred Tokyo. [symbol] [symbol] (15)

He moved to Tokyo. [symbol] [symbol] (16)

He transferred to Tokyo. [symbol] [symbol] (17)

He moved away from Tokyo. [symbol] [symbol] (18)

The candidate display unit 107 displays the English sentence candidates and corresponding machine translation results (Japanese translated sentences) side by side on the display device, as shown in FIG. 4. As for the display order of the English sentence candidates, these candidates may be ordered based on frequencies of appearance in the corpus, and may be displayed in the order of frequencies of appearance.

The user checks the English sentence candidates and corresponding Japanese translated sentences displayed on the display device, and selects an appropriate English sentence from them. In this example, the user selects the sentence (16). In one example, when the user selects an appropriate English sentence from the English sentence candidates (14) to (18) using the input device, the input sentence is automatically replaced with the selected English sentence. The preposition “to” included in the sentence (16) is not a preposition which is input by the user by intent, but it is a preposition provided by the foreign language writing support apparatus of the present embodiment. In this embodiment, by presenting English sentence candidates to the user together with corresponding Japanese translated sentences, foreign language sentences which are grammatically correct but do not have a meaning intended by the user can be suppressed from being created.

In this manner, upon reception of an English sentence in which an unknown part is described using a Japanese word from the user, the foreign language writing support apparatus according to the present embodiment presents one or more English sentence candidates to the user together with machine translation results (Japanese translated sentences). Thus, the user can easily select a desired English sentence. In this manner, a desired English sentence can be created by a few operations such as input and selection operations, that is, support of smooth writing of an English sentence can be attained.

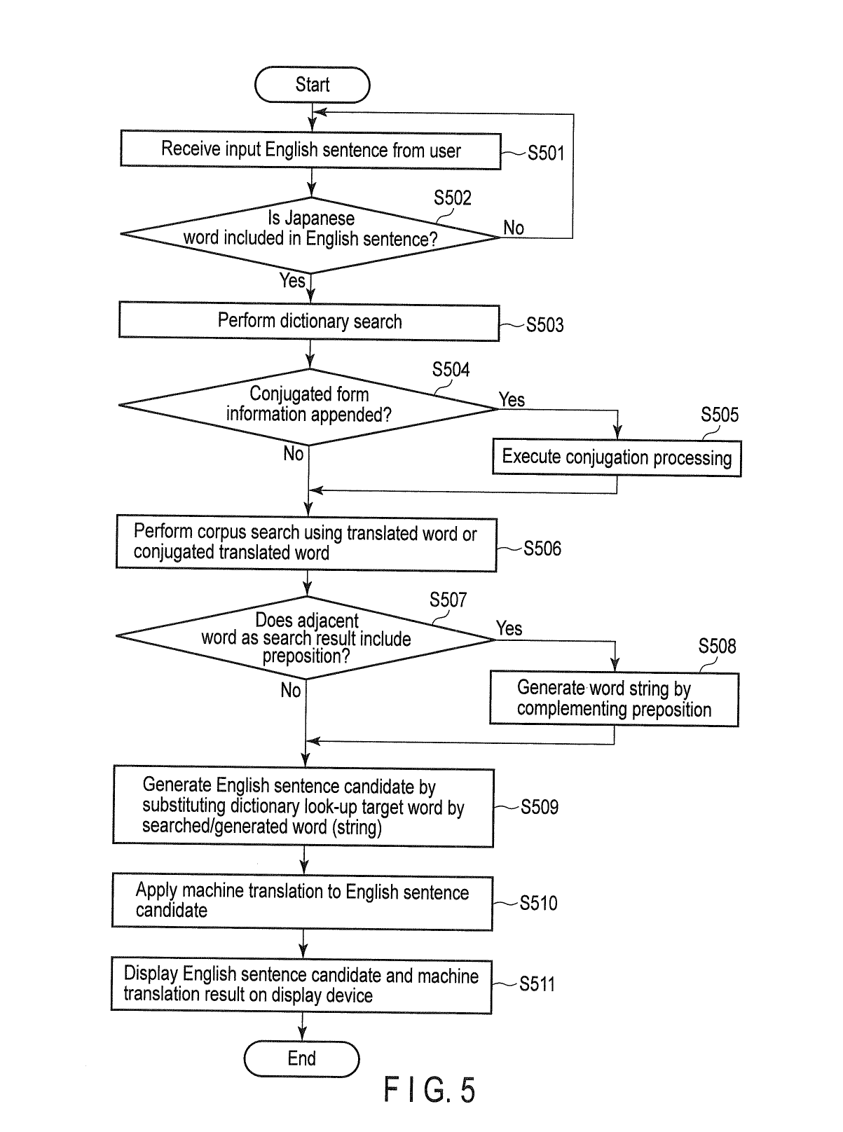

FIG. 5 schematically shows the processing sequence executed by the foreign language writing support apparatus. In step S501 of FIG. 5, the foreign language sentence input unit 101 receives input of an English sentence from the user. In step S502, the controller 108 judges whether or not the English sentence includes a Japanese word. If the English sentence does not include any Japanese word, the process returns to step S501, and the foreign language sentence input unit 101 accepts the next input English sentence. If the English sentence includes a Japanese word, the process advances to step S503.

In step S503, the dictionary search unit 102 performs a dictionary search using the Japanese word included in the English sentence as a search index to acquire one or more translated words corresponding to the Japanese word. In this case, assume that one translated word (for example, verb) is acquired by the dictionary search unit 102 for ease of explanation. In step S504, the controller 108 judges whether or not conjugated form information is appended to the Japanese word. If conjugated form information is appended, the process advances to step S505; otherwise, the process advances to step S506.

In step S505, the conjugated translated word generation unit 103 generates a conjugated translated word by conjugating the translated word acquired in step S503 according to the conjugated form information. In step S506, the word string generation unit 104 performs a corpus search for the translated word acquired in step S503 or the conjugated translated word acquired in step S505 to acquire one or more words connectable to the translated word or the conjugated translated word. More specifically, when the conjugated translated word is obtained in step S505, the word string generation unit 104 performs a corpus search for this conjugated translated word; when no conjugated translated word is obtained in step S505, it performs a corpus search for the translated word acquired in step S503. In step S507, the controller 108 judges whether or not the connectable words acquired in step S506 include a preposition. If a preposition is included, the process advances to step S508; otherwise, the process advances to step S509. In step S508, the word string generation unit 104 generates an extended word string which is a combination of the translated word and preposition. Note that when a search index is a noun, the word string generation unit 104 can execute processing for adding a definite article to the translated word or the like.

In step S509, the candidate generation unit 105 generates an English sentence candidate by replacing the Japanese word with the translated word acquired in step S503 or the conjugated translated word generated in step S505. Furthermore, the candidate generation unit 105 generates an English sentence candidate by replacing the Japanese word with the word string generated in step S508. In step S510, the machine translation unit 106 applies machine translation to the English sentence candidates. In step S511, the candidate display unit 107 displays the English sentence candidates on the display device together with corresponding machine translation results. In this manner, the foreign language writing support apparatus according to the present embodiment supports the user to write an English sentence.

As described above, upon reception of a foreign language sentence at least partially including a word in the mother language, the foreign language writing support apparatus according to the present embodiment generates one or more foreign language sentence candidates by replacing this word in the mother language with a corresponding translated word and an extended word string including this translated word, and presents the created foreign language sentence candidates to the user together with machine translation results. In this manner, the user can easily select a desired foreign language sentence, thus attaining smooth writing of a foreign language by the user.

### Second Embodiment

A foreign language writing support apparatus according to the second embodiment has the same arrangement as that shown in FIG. 1. In the present embodiment, English documents in a specific field are registered in a foreign language corpus.

In the present embodiment, as a practical example, assume that the user writes an English sentence having a meaning indicated by the following Japanese sentence (19).

[ [symbol] [symbol] ](19)

Note that an English translation of the Japanese sentence (19) is, for example, an English sentence [The advertisement is related to programming] or [The advertisement is associated with programming].

In this example, assume that an unknown word of the user is an adjective [ [symbol] ]. More specifically, the user knows a basic grammar SVC (Subject—Verb—Complement), and that a verb is [is], an English translation of the Japanese word [ [symbol] ] is [advertisement], and an English translation of the Japanese word [ [symbol] ] is [programming]. However, the user does not know the following:
an English translation of the Japanese word [ [symbol] [symbol] ].

In this case, the user inputs an English sentence indicated by, for example, the following sentence (20) to the foreign language sentence input unit 101.

The advertisement is [symbol] programming. (20)

In this case, a word (adjective) that the user wants to look up is input in Japanese. As for the sentence (20), the foreign language writing support apparatus according to the present embodiments supports the user to write an English sentence as follows.

A dictionary search unit 102 performs a dictionary search for the Japanese word (adjective) [ [symbol] ]. In this case, assume that the following three translated words are acquired as dictionary search results.

related

relevant

associated

A word string generation unit 104 searches a foreign language corpus for these translated words to acquire words connectable to these translated words. Subsequently, the word string generation unit 104 generates extended word strings by coupling or complementing corresponding connectable words to the translated words. In one example, a preposition “to” is obtained as a corpus search result for “related”, a preposition “to” is obtained as a corpus search result for “relevant”, and a preposition “with” is obtained as a corpus search result for “associated”, thus generating three extended word strings “related to”, “relevant to”, and “associated with”.

A candidate generation unit 105 generates English sentence candidates by replacing an input character string [ [symbol] ] with the translated words acquired by the dictionary search unit 102 and the word strings generated by the word string generation unit 104. In this example, English sentence candidates indicated by sentences (21) to (26) below are generated.

The advertisement is associated programming. (21)

The advertisement is related programming. (22)

The advertisement is related to programming. (23)

The advertisement is associated with programming. (24)

The advertisement is relevant programming. (25)

The advertisement is relevant to programming. (26)

In the present embodiment, the translated words “related”, “relevant”, and “associated”, and the extended word strings “related to”, “relevant to”, and “associated with” are ordered in descending order of frequency of appearance in the foreign language corpus, thus deciding a display order of the English sentence candidates. Since English sentences in the specific field are registered in the foreign language corpus, expressions popularly used in that field are preferentially presented.

English sentence candidates to be generated change depending on the contents of the foreign language corpus registered in advance by the user. For example, when the user registers English sentences in the specific field in the foreign language corpus, the foreign language corpus includes “related to” and “relevant to”, but often does not include “associated”. In this case, a word (“with”) connectable to “associated” is not acquired. For this reason, the word string “associated with” is not generated. That is, the sentence candidate indicated by the sentence (24) is not generated.

When the foreign language corpus does not include “associated”, a candidate display unit 107 displays five English sentence candidates on a display device together with machine translation results of a machine translation unit 106, as shown in FIG. 6. For example, since the English sentence (21) is grammatically correct, translation by the machine translation has succeeded. However, as can be seen from the machine translation result, this English sentence has a meaning different from that intended by the user.

As described above, according to the second embodiment, the same effects as in the first embodiment can be obtained. In addition, by registering foreign language sentences in a specific field in the foreign language corpus, and preferentially presenting expressions popularly used in that field to the user, the user can write an English sentence suited to that field. Furthermore, grammatical errors and semantic errors which cannot be suppressed by a simple dictionary look-up can also be suppressed.

(Modification)

A foreign language writing support apparatus according to a modification of each of the above embodiments will be described below. In the above embodiments, the dictionary search unit 102 acquires a foreign language word corresponding to a word in a mother language included in an input foreign language sentence as a translated word. By contrast, in this modification, the dictionary search unit 102 acquires the foreign language word corresponding to the word in the mother language included in the input foreign language sentence, and also an idiom including that foreign language word as translated words. Using the example described in the second embodiment, the dictionary search unit 102 according to the modification acquires the word “related” and idiom “related to” as translated words. The translated word “related to” corresponds to an extended word string generated by the word string generation unit 104. Therefore, when the dictionary search unit 102 acquires a word and an idiom including that word as translated words, the word string generation unit 104 can be omitted.

Instructions described in the processing sequence in the aforementioned embodiment can be executed based on a program as software. A general-purpose computer system stores this program in advance, and loads this program, thus obtaining the same effects as those of the aforementioned foreign language writing support apparatus. The instructions described in the above embodiment are recorded as a program which can be executed by a computer in a magnetic disk (flexible disk, hard disk, etc.), optical disk (CD-ROM, CD-R, CD-RW, DVD-ROM, DVD+R, DVD+RW, etc.), semiconductor memory, or similar recording medium. A storage format is not particularly limited as long as a recording medium is readable by a computer or embedded system. A computer reads the program from this recording medium, and controls a CPU to execute the instructions described in the program based on that program, thereby implementing the same operations as those of the foreign language writing support apparatus of the aforementioned embodiment. Of course, the computer can acquire or load the program via a network.

Based on the instruction of the program installed from the recording medium in the computer or embedded system, an operating system (OS), database management software, middleware (MW) of a network or the like, or the like, which run on the computer, may execute some of processes required to implement this embodiment.

Furthermore, the recording medium of this embodiment is not limited to a medium independent from the computer or embedded system, but it includes a recording medium which stores or temporarily stores a program downloaded via a LAN, Internet, or the like.

Moreover, the number of recording media is not limited to one. A case in which the processing according to this embodiment is executed from a plurality of media is included in the recording medium according to this embodiment, and arbitrary medium configurations may be adopted.

Note that the computer or embedded system according to this embodiment is used to execute respective processes of this embodiment based on the program stored in the recording medium, and may have an arbitrary arrangement such as a single apparatus (for example, a personal computer or microcomputer) or a system which connects a plurality of apparatuses via a network.

The computer in this embodiment is not limited to a personal computer, and includes an arithmetic processing device or microcomputer included in an information processing apparatus, and generically represents a device or apparatus which implements the functions of this embodiment based on the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A foreign language writing support apparatus comprising:
an input unit configured to receive input of a sentence in a foreign language including a word in another language;
a dictionary search unit configured to perform a dictionary search for the word in the other language and to acquire a translated word which is a word in the foreign language corresponding to the word in the other language;
a candidate generation unit configured to generate one or more foreign language sentence candidates including a first foreign language sentence candidate generated by replacing the word in the other language with the translated word;
a machine translation unit configured to generate one or more machine translation results by applying machine translation to the one or more foreign language sentence candidates; and
a display unit configured to display the one or more foreign language sentence candidates together with the one or more machine translation results.

2. The apparatus according to claim 1, further comprising a word string generation unit configured to generate an extended word string including the translated word,
wherein the candidate generation unit generates a second foreign language sentence candidate by replacing the word in the other language with the extended word string if the extended word string is generated by the word string generation unit, the second foreign language sentence candidate being included in the one or more foreign language sentence candidates.

3. The apparatus according to claim 1, further comprising a conjugated translated word generation unit configured to generate, if the sentence includes conjugated form information designating a conjugated form of the word in the other language, a conjugated translated word by conjugating the translated word according to the conjugated form information,
wherein the candidate generation unit generates the first foreign language sentence candidate by replacing the word in the other language with the conjugated translated word.

4. The apparatus according to claim 2, wherein the word string generation unit comprises a storage unit configured to store a foreign language corpus, and a foreign language search unit configured to acquire a word connectable to the translated word by searching the foreign language corpus using the translated word, and to generate the extended word string by coupling the connectable word to the translated word.

5. The apparatus according to claim 4, wherein the candidate generation unit decides a display order of the one or more foreign language sentence candidates based on frequencies of appearance of the translated word and the extended word string in the foreign language corpus.

6. The apparatus according to claim 2, wherein the extended word string is obtained by complementing a preposition or a definite article to the translated word.

7. A foreign language writing support method comprising:
receiving input of a sentence in a foreign language including a word in another language;
performing a dictionary search for the word in the other language and acquiring a translated word which is a word in the foreign language corresponding to the word in the other language;
generating one or more foreign language sentence candidates including a first foreign language sentence candidate generated by replacing the word in the other language with the translated word;
a machine translation unit configured to generate one or more machine translation results by applying machine translation to the one or more foreign language sentence candidates; and
a display unit configured to display the one or more foreign language sentence candidates together with the one or more machine translation results.

8. The method according to claim 7, further comprising generating an extended word string including the translated word,
wherein the generating the one or more foreign language sentence candidates comprises generating a second foreign language sentence candidate by replacing the word with the extended word string if the extended word string is generated by the word string generation unit, the second foreign language sentence candidate being included in the one or more foreign language sentence candidates.

9. The method according to claim 7, further comprising generating, if the sentence includes conjugated form information designating a conjugated form of the word in the other language, a conjugated translated word by conjugating the translated word according to the conjugated form information,
wherein the candidate generation unit generates the first foreign language sentence candidate by replacing the word in the other language with the conjugated translated word.

10. The method according to claim 8, wherein the generating the extended word string comprises acquiring a word connectable to the translated word by searching a foreign language corpus using the translated word, and generating the extended word string by coupling the connectable word to the translated word.

11. The method according to claim 10, wherein the generating the one or more foreign language sentence candidates comprising deciding a display order of the one or more foreign language sentence candidates based on frequencies of appearance of the translated word and the extended word string in the foreign language corpus.

12. The method according to claim 8, wherein the extended word string is obtained by complementing a preposition or a definite article to the translated word.

13. A non-transitory computer readable medium including computer executable instructions, wherein the instructions, when executed by a processor, cause the processor to perform a method comprising:
receiving input of a sentence in a foreign language including a word in another language;
performing a dictionary search for the word in the other language and acquiring a translated word which is a word in the foreign language corresponding to the word in the other language;
generating one or more foreign language sentence candidates including a first foreign language sentence candidate generated by replacing the word in the other language with the translated word;
a machine translation unit configured to generate one or more machine translation results by applying machine translation to the one or more foreign language sentence candidates; and
a display unit configured to display the one or more foreign language sentence candidates together with the one or more machine translation results.

14. The medium according to claim 13, further comprising generating an extended word string including the translated word,
wherein the generating the one or more foreign language sentence candidates comprises generating a second foreign language sentence candidate by replacing the word with the extended word string if the extended word string is generated by the word string generation unit, the second foreign language sentence candidate being included in the one or more foreign language sentence candidates.

15. The medium according to claim 13, further comprising generating, if the sentence includes conjugated form information designating a conjugated form of the word in the other language, a conjugated translated word by conjugating the translated word according to the conjugated form information,
wherein the candidate generation unit generates the first foreign language sentence candidate by replacing the word in the other language with the conjugated translated word.

16. The medium according to claim 14, wherein the generating the extended word string comprises acquiring a word connectable to the translated word by searching a foreign language corpus using the translated word, and generating the extended word string by coupling the connectable word to the translated word.

17. The medium according to claim 16, wherein the generating the one or more foreign language sentence candidates comprising deciding a display order of the one or more foreign language sentence candidates based on frequencies of appearance of the translated word and the extended word string in the foreign language corpus.

18. The method according to claim 14, wherein the extended word string is obtained by complementing a preposition or a definite article to the translated word.
